(19) United States
(12) Patent Application Publication
(10) Pub. No.: US 2008/0309012 A1
(43) Pub. Date: Dec. 18, 2008

(54) Method and a Device for Supply of at Least One Substance Into Interspace Between Mutually Movable, Coaxial Structural Elements

(75) Inventor: Magne Hystad, Kopervik (NO)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KARM AS, Kopervik (NO)

(21) Appl. No.: 11/794,616

(22) PCT Filed: Jan. 4, 2006
(86) PCT No.: PCT/NO06/00001

§ 371 Date: Jul. 3, 2007

(30) Foreign Application Priority Data
Jan. 5, 2005 (NO) 20050057

(51) Int. Cl. F16J 15/48

(52) U.S. Cl. 277/300; 277/583

(57) ABSTRACT

A method and a device for the supply of at least one substance (12; 27) into the interspace (3; 22)between mutually moving, coaxial structural elements (1, 1′ and 2; 20;20′ and 21), wherein the substance (12; 27) is introduced under pressure into the interspace (3), and wherein excess volume of substance (12; 27) that is introduced is caused to exit the interspace (3; 22). The interspace (3; 22) is closed off at at least one axial end thereof by means of at least one annular, spring-loaded seal (9; 16; 23; 24; 37; 38) which is secured in a retaining part (7; 31; 32) associated with one of the structural elements (1, 1′; 20, 20′)and has a contact face against the other structural element (2; 21), wherein the substance (12; 27), at a corresponding pressure and simultaneously with the supply into the interspace (3; 22), is also separately supplied to a pressure- applying face of the seal (9; 16; 23; 24; 37; 38).

The present invention relates to a method and a device for the supply of at least one substance into the interspace between mutually movable, coaxial structural elements.

It is previously known to lubricate mutually movable structural elements, e.g., elements which move relative to each other in an axial direction, typically such as telescoping parts, by introducing a lubricant, e.g., lubricating grease, under pressure into the narrow interspace between the structural elements. To ensure that the grease moves in one particular main direction, and not just the shortest way out, especially when introducing grease under pressure via a lubricator nipple, an annular seal is provided close to the grease introduction point at an axial end of the grease receiving volume. However, it is a known phenomenon that on the introduction of lubricating grease, a seal of this kind does not necessarily remain leak-proof.

Furthermore, there has been a need for the introduction under pressure of cleaning fluid into the interspace to clean the interspace of grease and not least wear-producing contaminants such as sand particles, clay, mud and the like, without having to resort to major disassembly.

The problems that the present invention aims to remedy have, inter alia, been known in connection with so-called vertical movement locking towing pins and so-called chain and wire forks for locking, e.g., a chain in position.

The characteristic features of the invention are apparent from the attached independent claims and the respective subsidiary claims associated therewith, and from the following, for the invention non-limiting, description with reference to the attached drawings in order to illustrate aspects of the invention.

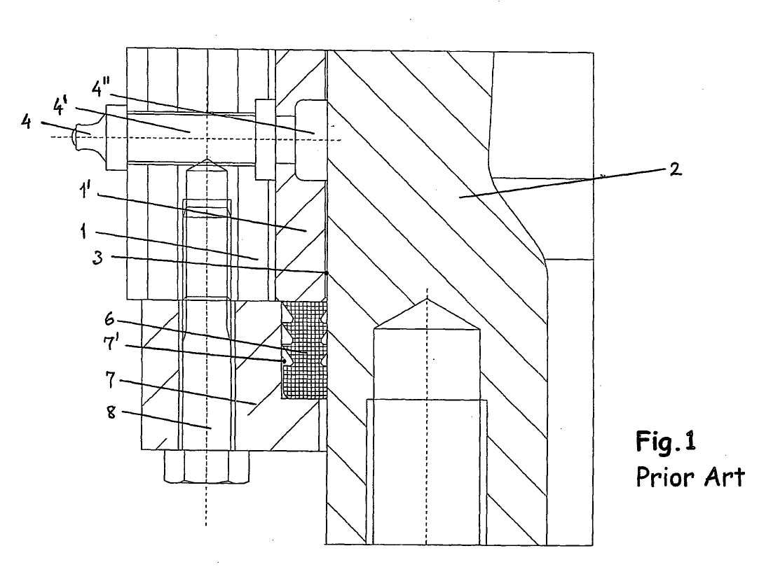

FIG. 1 illustrates the prior art.

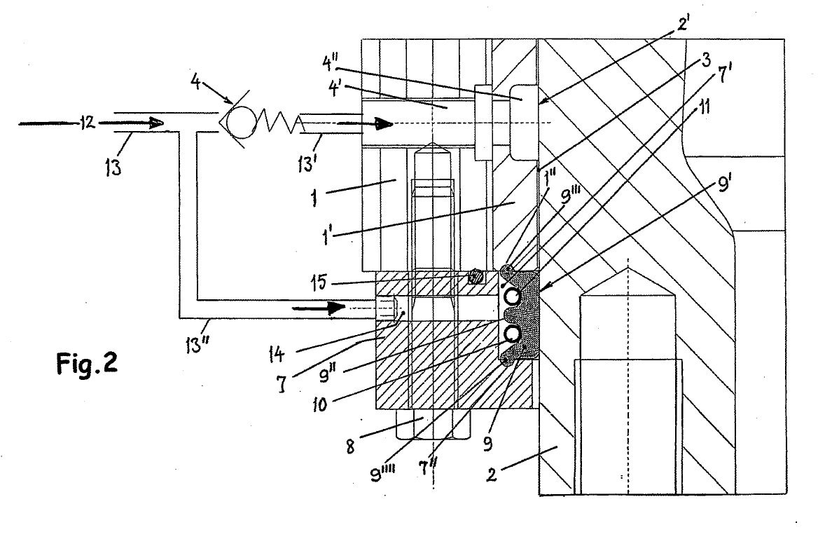

FIG. 2 shows a first aspect of the invention.

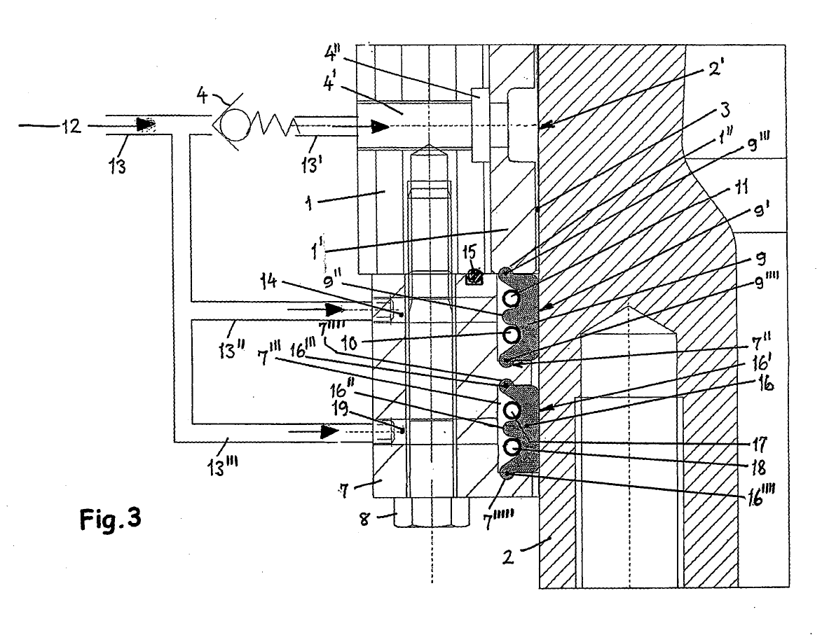

FIG. 3 shows a modification of the embodiment in FIG. 2.

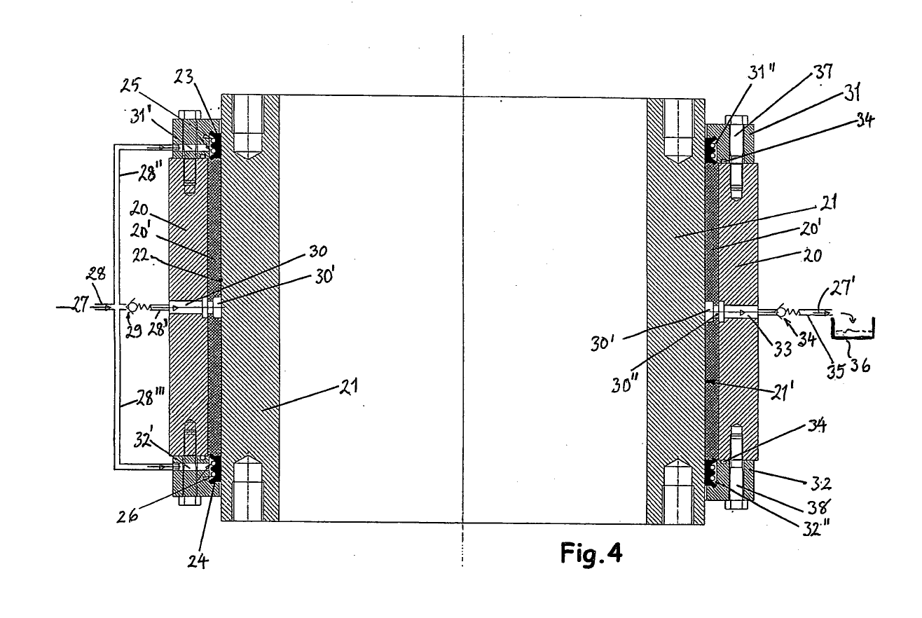

FIG. 4 shows a second aspect of the invention.

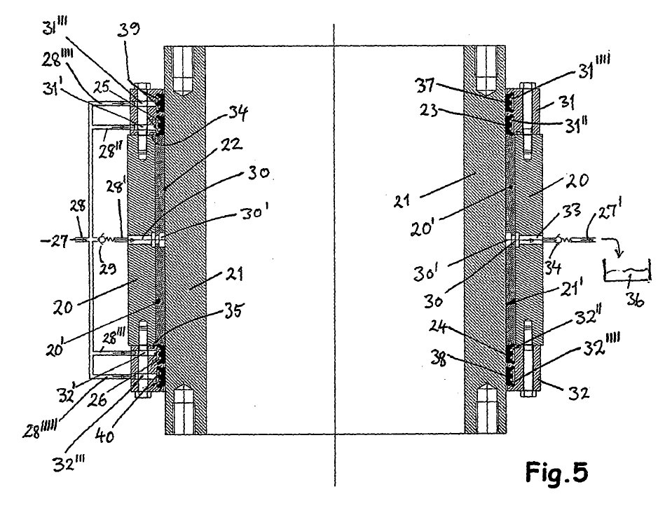

FIG. 5 shows a modification of the embodiment in FIG. 4.

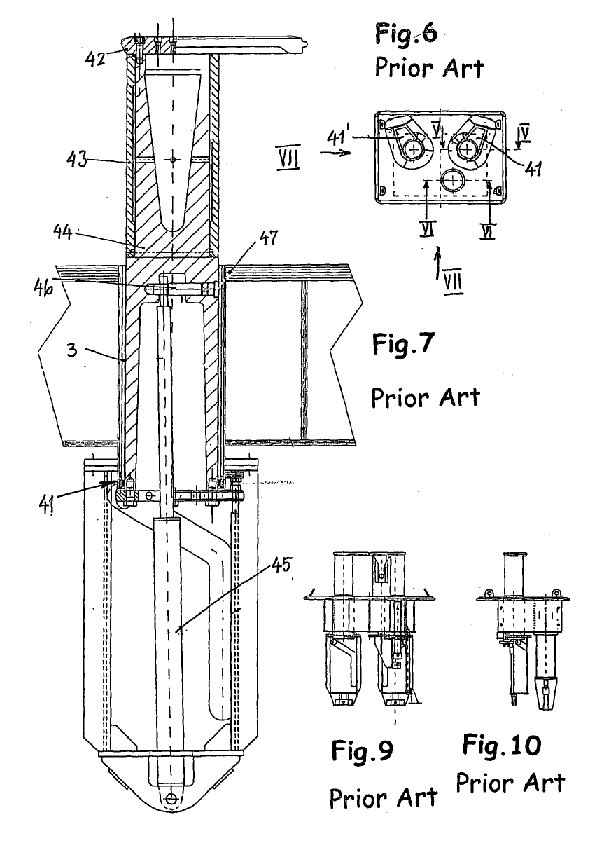

FIG. 6 is a top view of a known combined towing pin and chain fork installation in which the invention may be used.

FIG. 7 shows the section VII-VII in FIG. 6

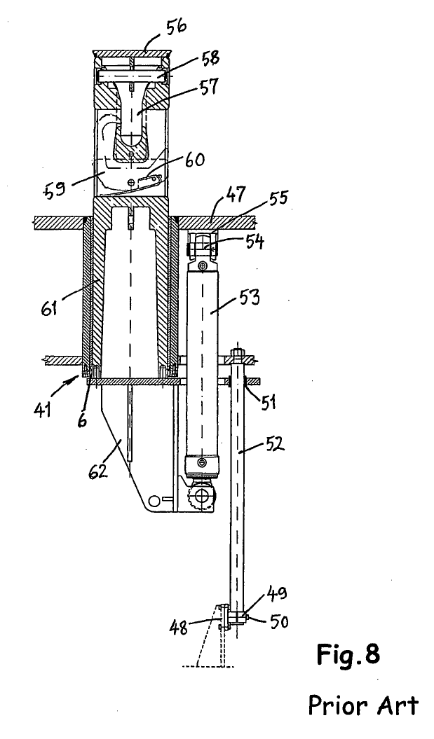

FIG. 8 shows the section VIII-VIII in FIG. 4.

FIG. 9 is a vertical elevation of the installation in FIG. 6 seen in the direction IX.

FIG. 10 is a vertical elevation of the installation in FIG. 6 seen in the direction X:

In FIG. 1 it is shown how two mutually movable, coaxial elements 1, 1′ and 2 with an interspace 3 between them can be supplied with lubricant (not shown) passed to a lubricating outlet or lubricating manifold 4″ from a lubricator nipple 4 via a lubricating channel 4′. An annular seal 6 with sealing lips is provided in a recess 7′ on a retaining piece 7 and closes one of the outlets from the interspace 3 axially. A bolt 8 is provided to secure the retaining piece 7 to the element 1′. When lubricant is introduced under pressure into the interspace 3 via the nipple 4, the channel 4′ and the outlet 4″, the seal 6 will attempt to prevent lubricant from seeping out past the seal. As the seal becomes worn in consequence of the mutually movable elements 1, 1′ and 2 moving a multitude of times relative to each other, it will have difficulties in remaining leak-proof. The part 1′ is expediently made as a sliding bearing, e.g., of bronze. Wear may be caused, inter alia, by contaminants such as sand, mud, clay, dust and dirt. Should the need arise to flush out the interspace 3 in order to then introduce lubricant, this is made difficult by the inadequate sealing capacity of the seal 6, as it is undesirable that contaminants should be flushed past the seal 6 and that any such contaminants should remain in the vicinity of the seal, which would later contribute to the reduced sealing capacity of the seal when lubricant is introduced and to a risk of increased wear on the seal and the surface of the element 2.

FIG. 2 shows a modification of the solution illustrated in FIG. 1. The seal 6 which is shown in FIG. 1 has been replaced by an annular seal 9 in FIG. 2. Seen in cross-section, the inner side 9′ of the seal, i.e., the side facing the element 2, is preferably straight, whilst the outer side 9″ is wave-shaped. The ring seal 9 is made so that it has a piston function. Such piston function is obtained partly by providing in at least two of the valleys of the a wave-shape a respective spring 10, 11, as for example, a 6 mm helical spring, which thus encircles the ring seal and will cause the static sealing pressure that the seal is to exert with its inner side 9′ against the element 2 to remain at an acceptable level, e.g., 800 mm Hg/cm2. It is of course important to maintain this sealing pressure after lubricant, such as lubricating grease, has been introduced into the interspace 3. As explained in connection with FIG. 1, lubricant, schematically indicated by the arrow 12, is introduced into the interspace 3 via a supply hose or a supply pipe 13, the valve 4, an additional pipe 13′, the channel 4′ and the outlet 4″. From the hose or pipe 13 there is a branch 13″ that is secured in a channel 14 in the retaining piece 7. The channel 14 leads into the recess 7′, and this means that lubricant under pressure is at the same time also directed in towards the outer side 9″ of the ring seal 9. When pressurised lubricant is thus, e.g., under a pressure of 3 bars, forced into the interspace 3, this results simultaneously in the ring seal 9 being subjected to a corresponding pressure, which causes the ring seal 9 to effect complete sealing whilst the interspace 3 is filled with lubricant. This means that the lubricant will move in the interspace 3 away from the area of the ring seal 9, and that no lubricant will leak past the ring seal 9. At each end of the wavy portion 9″ there is preferably a respective bead 9″′, 9″″ which is fitted in a respective recess 1″ in the element 1′ and 7″ in the retaining piece 7. Thus, the ring seal 9 has a defined positioning in the recess 7′, whilst, inter alia, the bead 9″′ ensures that any lubricant from the interspace 3 does not enter the recess 7′. An O-ring 15 is advantageously disposed between the retaining piece 7 and the element 1 to prevent any lubricant from the recess 7′ from seeping out into a possible gap between the retaining piece 7 and the element 1.

The technical solution according to FIG. 2 also provides other advantageous possibilities. The use of a ring seal 9 also permits an efficient washing of the interspace 3 present at any given time between the elements 1′ and 2. Instead of then supplying lubricant under pressure via the hose or the pipe 13, the valve 4, the pipe 13′ and the channel 4′, and the pipe 13″ and the channel 14, a cleaning agent is now supplied. This cleaning agent may expediently contain fat-dissolving substances. The cleaning agent may optionally be water-soluble. The cleaning agent is thus flushed through the interspace, optionally whilst the mutually movable elements 1, 1′ and 2 are moved axially relative to each other. Thus, the whole of the inner side of element 1′ will be cleaned and at the same time the whole of the cylindrical outer side 2′ of the element 2 will be cleaned. Subsequently, for example, clean water can be introduced to flush out the interspace, whereafter lubricant is introduced, as described above. Whilst lubricant is introduced under pressure, it is of course possible to allow the elements 1, 1′ and 2 to move relative to each other, or optionally allow them to be motionless.

The solution according to FIG. 2 is suitable in particular when the mutually movable, coaxial elements are mutually displaceable in an axial direction, but is also suitable in the event that the elements are only mutually rotatable. Furthermore, the solution is also useful when the structural elements are not only mutually displaceable in the axial direction, but where such movement is combined with a mutually rotatable movement.

Although FIG. 2 shows just one seal, there may of course be two or more seals in the sealing end of the interspace 3. This is shown in more detail in FIG. 3, from which an additional annular seal 16 can be seen. Seen in cross-section, the inner side 16′ of the seal, i.e., the side facing the element 2, is preferably straight, whilst the outer side 16″ is wave-shaped. Like the ring seal 9, the ring seal 16 is also made so that it has a piston function. Such piston function is obtained partly by providing in at least two of the troughs of the corrugation a respective spring 17, 18, as for example a 6 mm helical spring, which thus encircles the ring seal and causes the static sealing pressure that the seal is to exert with its inner side against the element 2 to remain at an acceptable level, e.g., 800 mm Hg/cm2. It is of course important to be able maintain this sealing pressure after lubricant, such as lubricating grease, has been introduced into the interspace 3, the seal 16 serving to provide an additional sealing effect in addition to the effect provided by the seal 9. As explained in connection with FIGS. 1 and 2, lubricant, schematically indicated by the arrow 12, is introduced into the interspace 3 via a supply hose or a supply pipe 13, the valve 4, an additional pipe 13′, the channel 4′ and the outlet 4″. From the hose or pipe 13, there is, as shown in FIG. 2, a branch 13″ which is secured in a channel 14 in the retaining piece 7. Similarly, an additional branch 13″′ is provided for the function of the ring seal 16, which is secured in a channel 19. The channel 14 leads into a recess 7″′ and this means that lubricant under pressure is at the same time also directed in towards the outer side 16″″ of the ring seal 16. When pressurised lubricant is thus, e.g., under a pressure of 3 bars, forced into the interspace 3, this results simultaneously in the ring seal 16 being subjected to a corresponding pressure, which causes the ring seal 16 to effect complete sealing and supplementary sealing to the sealing effected by the ring seal 9 whilst the interspace 3 is filled with lubricant. This means that the lubricant will move in the interspace 3 away from the area of the ring seal 9 and consequently also the ring seal 16, and that no lubricant will leak past the ring seals 9 and 16. At each end of the wavy portion 16″ there is preferably a respective bead 16″′, 16″″ which is fitted in a respective recess 7″″, 7″″′ in the retaining piece 7. Thus, the ring seal 16 also in this case has a defined positioning in the recess 7″′.

The technical solution according to FIG. 3 also provides other advantageous possibilities as shown and described in connection with FIG. 2. The use of ring seals 9 and 16 also permits an efficient washing of the interspace 3 present at any given time between the elements 1′ and 2. Instead of then supplying lubricant under pressure via the hose or pipe 13, the valve 4, the pipe 13′ and the channel 4′, and the pipes 13″ and 13″′ and the channels 14 and 18, a cleaning agent is now supplied. This cleaning agent may also lo expediently contain fat-dissolving substances.

The solution according to FIG. 3, like the solution in FIG. 2, is suitable in particular when the mutually movable coaxial elements are mutually displaceable in an axial direction, but is also suitable in the event that the elements are only mutually rotatable. Furthermore, the solution is also useful where the structural elements are not only mutually displaceable in the axial direction, but also where such movement is combined with a mutually rotatable movement.

A solution which is particularly favourable in the event that the two coaxial elements are only mutually rotatable, but which also can be used where the two elements are axially mutually displaceable, or both simultaneously, can be seen from FIG. 4.

In this solution there are two mutually movable elements 20, 20′ and 21 with an interspace 22 between them. The part 20′ may optionally be of a softer material than the parts 20, 21, for example, it may be of bronze. Furthermore, an annular seal 23; 24 is arranged at a first and a second axial end of the element 20, 20′. As in the embodiment in FIGS. 2 and 3, the inner side of the seals, i.e., the side facing the element 21, seen in section, is preferably straight, whilst the outer side is wavy. In this case too, the ring seal 23, 24 is also made so that it has a piston function. Such piston function is obtained partly by providing in at least two of the valleys of the wave-shape a respective spring, in this figure indicated generally by the reference numerals 25, 26 for the seals 23, 24 respectively. As for the embodiment in FIGS. 2 and 3, these springs may each be formed of, e.g., a 6 mm helical spring which thus surrounds the ring seal and will cause the static sealing pressure that the seal with its inner side is to exert against the element 21 to remain at an acceptable level, e.g., 800 mm Hg/cm2. As explained in connection with FIGS. 2 and 3, it is important to be able to maintain this sealing pressure after lubricant, such as lubricating grease, has been introduced into the interspace 22.

Lubricant, schematically indicated by the arrow 27, can be introduced into the interspace 22 via a supply hose or a supply pipe 28, a valve 29, an additional pipe 28′, a channel 30 in the element 20 and a lubricating outlet or a lubricating manifold 30′. From the hose or pipe 28, there are branches 28″, 28″′ which are secured in a respective channel 31′; 32′ in a retaining piece 31; 32. The channel 31′; 32′ leads into a respective recess 31″; 32″ in the retaining piece 31; 32. This means that lubricant under pressure is at the same time also directed in towards the outer side of the ring seals 23; 24. When pressurised lubricant is thus, e.g., under a pressure of 3 bars, forced into the interspace 22, this results simultaneously in the ring seals 23, 24 being subjected to a corresponding pressure, which causes the ring seals 23, 24 to effect complete sealing whilst the interspace 22 is filled with lubricant. This means that the lubricant will move in the interspace 3 without any lubricant leaking out past the ring seal 23, 24.

Excess lubricant 27′ will exit via the lubricating manifold or lubricating outlet 30′ at a discharge point 30″ thereon and be conducted via a channel 33, a valve 34 and a pipe 35 to a collecting reservoir 36.

As shown in FIG. 2, at each end of the corrugated portion of the ring seal there is a respective bead which is fitted in a respective recess on the element 20′ and the respective retaining pieces 31; 32. Thus, the ring seals 23; 24 have a defined positioning in the respective recess 31″; 32″, whilst, inter alia, the bead ensures that lubricant from the interspace 22 does not enter the recess 31′; 32′. An O-ring 34; 35 is advantageously disposed between the respective retaining piece 31; 32 and the element 20 to prevent any lubricant from the recesses from seeping out into a possible gap between the retaining piece 31; 32 and the element 20.

Like the technical solution in FIGS. 2 and 3, the solution in FIG. 4 also gives other advantageous possibilities. The use of the solution for sealing which the ring seals 23; 24 provide, also permits an efficient washing of the interspace 22 present at any given time between the elements 20′ and 21. Instead of then supplying lubricant under pressure via the hose or pipe 28, the valve 29, the pipe 28′ and the channel 30, and the pipes 28″; 28″′ and the channels 31′; 32′, a cleaning agent is now supplied. This cleaning agent may expediently contain fat-dissolving substances. The cleaning agent may optionally be water-soluble. The cleaning agent is thus flushed through the interspace, optionally whilst the mutually movable elements are rotated relative to each other or moved axially relative to each other. Thus, the whole inner side of the element 20′ will be cleaned and at the same time the whole of the cylindrical outer side 21′ of the element 21 will be cleaned. Then, e.g., water may be introduced to flush out the interspace, whereupon lubricant is introduced, as indicated above. Excess cleaning agent is passed from the outlet 30′, via the discharge point 30″, the channel 33, the valve 34 and the pipe 35 to a collecting reservoir of, e.g., the same type as the reservoir 36. Whilst cleaning agent is introduced under pressure, it is of course also possible to allow the elements 20, 20′ and 21 to move relative to each other, or optionally allow them to be motionless. After use of cleaning agent, e.g., clean water can be introduced to flush out the interspace, whereupon lubricant is introduced as indicated above. Whilst lubricant is introduced under pressure, it is of course possible to allow the elements 20, to 20 and 21 move relative to each other, or optionally allow them to be motionless.

The retaining pieces 31, 32, as shown in FIG. 4, are secured to the element 20 using a plurality of bolts 37; 38.

FIG. 5 represents a modification of the embodiment shown in FIG. 4, and the modification is based on the modification found in FIG. 3 that is based on FIG. 2.

In this solution there are two mutually movable elements 20, 20′ and 21 with an interspace 22 between them. As before, the part 20′ may optionally be of a softer material than the parts 20, 21, for example, it may be of bronze. Furthermore, two annular seals 23; 37 and 24; 38 are provided at a first and a second axial end of the element 20, 20′. As in the embodiment in FIGS. 2 and 3, the inner side of the seals, i.e., the side facing the element 21, seen in cross-section, is preferably straight, whilst the outer side is wave-shaped. In this case too, the seals are made to have a piston function. Such piston function is obtained partly by providing in at least two of the valleys of the wave-shape a respective spring, generally indicated here by the reference numerals 25; 30 and 26; 40 for the seals 23; 37 and 24; 38 respectively. As for the embodiment in FIGS. 2 and 3, these springs may each consist of, e.g., a 6 mm helical spring which thus surrounds the ring seal and will cause the static sealing pressure which the seal with its inner side is to exert against the element 21 to remain at an acceptable level, e.g., 800 mm Hg/cm2. As explained in connection with FIGS. 2 and 3, it is important to maintain this sealing pressure after lubricant, such as lubricating grease, has been introduced into the interspace 22. Lubricant, schematically indicated by arrow 27, can be introduced into the interspace 22 via a supply hose or a supply pipe 28, a valve 29, an additional pipe 28′, a channel 30 in the element 20 and a lubricating outlet or a lubricating manifold 30′. From the hose or pipe 28 there are branches 28″, 28″′, 28″″ and 28″″′ which are fixed in a respective channel 31′; 32′ and 31″′; 32″′ in a retaining piece 31; 32.

The channels 31′; 32′; 31″′, 32″′ lead into a respective recess 31″; 32″;31″″, 32″″ in the retaining pieces 31; 32. This means that lubricant under pressure is at the same time also directed in towards the outer side of the ring seals 23; 24; 37; 38. When pressurised lubricant is thus, e.g., under a pressure of 3 bars, forced into the interspace 22, this results simultaneously in the ring seals 23, 24 and 37, 38 being subjected to a corresponding pressure, which causes them to effect complete sealing whilst the interspace 22 is filled with lubricant. In reality, the ring seals 37, 38 will provide supplementary sealing to the ring seals 23, 24. This means that the lubricant will move in the interspace 3 without any lubricant leaking past the ring seals 23, 37 and 24, 38.

Excess lubricant 27′ will exit via the lubricating manifold or lubricating outlet 30′ at a discharge point 30″ thereon and be passed via a channel 33, a valve 34 and a pipe 35 to a collecting reservoir 36, as shown and explained in connection with FIG. 4.

As shown in FIG. 2, at each end of the wavy portion of the ring seals 23, 24 there is a respective bead which is fitted in a respective recess on the element 20′ and the respective retaining pieces 31; 32. Similarly, the ring seals 37, 38 and their respective beads will be fitted in respective recesses in the retaining pieces 31; 32. Thus, the ring seals 23; 24 and 37; 38 have a defined positioning in respective recess 31″; 32″ and 31″″; 32″″. An O-ring 34; 35 is advantageously disposed between the respective retaining piece 31; 32 and the element 20 to prevent any lubricant from the recesses from seeping out into a possible gap between the retaining piece 31; 32 and the element 20.

Like the technical solution in FIGS. 2 and 3, the solution in FIG. 4 also provides other advantageous possibilities. The use of the sealing that the ring seals 23; 24; 37; 38 provide also permits efficient washing of the interspace 22 present at any given time between the elements 20′ and 21. Instead of then supplying lubricant under pressure via the hose or the pipe 28, the valve 29, the pipe 28′ and the channel 30, and the pipes 28″; 28″′ and the channels 31′; 32′, cleaning agent is now supplied. This cleaning agent may expediently contain fat-dissolving substances. The cleaning agent may optionally be water-soluble. The cleaning agent is thus flushed through the interspace, optionally whilst the mutually movable elements are rotated relative to each other or are moved axially relative to each other. Thus, the whole of the inner side of the element 20′ will be cleaned and at the same time the whole of the cylindrical outer side 21′ of the element 21 will be cleaned. Subsequently, e.g. clean water can be introduced to flush out the interspace, whereupon lubricant is introduced, as indicated above. Excess cleaning agent is passed out from the outlet 30′ via the discharge point 30″, the channel 33, the valve 34 and the pipe 35 to a collecting reservoir of, e.g., the same type as the reservoir 36. Whilst cleaning agent is introduced under pressure, it is of course possible to allow the elements 20, 20′ and 21 to move relative to each other, or optionally allow them to be motionless. After use of cleaning agent, e.g., clean water may be introduced to flush out the interspace, whereupon lubricant is introduced, as indicated above. Whilst lubricant is introduced under pressure, it is of course possible to allow the elements 20, 20′ and 21 to move relative to each other, or optionally allow them to be motionless.

The prior art that is shown in FIGS. 6-10 will now be described just briefly in order to give an understanding of how the invention advantageously may be used on operational equipment on board, inter alia, ships, although this use is only exemplary without thus limiting other uses of the invention.

As shown in FIGS. 2 and 3 compared with FIG. 1, the invention requires relatively few modifications of known equipment to work as intended. The relevant modifications required are carried out only in the indicated area denoted by the reference numeral 41. The modifications are carried out only on parts of the equipment that are stationary.

In brief, the reference numerals in FIGS. 6-10 represent the following:

42, 42′=wire/chain locking plate (locks against excessively large vertical movement)
43=rolling part of towing pin 38
44=towing pin
45=hydraulic cylinder
46=plug for hydraulic cylinder
47=ship's deck
48=fixing bracket
49=pipe clamp
50=fixing screw
51=lining
52=guide bar
53=cylinder
54=shaft for cylinder
55=bracket
56=cover
57=U-part of fork for engagement with chain link
58=bolt for cover
59=hook
60=spring for hook
61=fork for gripping chain or wire clamp
62=fixing bracket

1. A method for supplying at least one substance into the interspace between mutually movable, coaxial structural elements, wherein the substance is introduced under pressure into the interspace, and wherein excess volume of the substance introduced is caused to exit the interspace, characterised in
that the interspace is closed off at at least one axial end by means of at least one annular, spring-loaded seal which is secured in a retaining piece associated with one of the structural elements and has a contact face against the other structural element, wherein the substance, at a corresponding pressure and simultaneously with the supply to the interspace, is also separately supplied to a pressure-applying face of the seal.

2. A method as disclosed in claim 1, characterised in
that the closing off of the interspace takes place at just one axial end thereof; and
that the excess volume in a known way per se is caused to exit the interspace via an axially open end area of the interspace.

3. A method as disclosed in claim 1, characterised in
that the closing off of the interspace takes place at both of the axial ends of the interspace; and
that the excess volume in caused to exit the interspace via one outlet located between said ends.

4. A method as disclosed in claim 1, 2, or 3, characterised in
that said at least one end is closed off by two seals.

5. A method as disclosed in claim 1, characterised in
that said substance is a lubricant or a cleaning agent.

6. A device for the supply of at least one substance into the interspace between mutually movable, coaxial structural elements, wherein the substance is introducable under pressure into the interspace, and wherein excess volume of the introduced substance is caused to exit the interspace, characterised in
that the interspace is closed off at at least one axial end by means of at least one annular, spring-loaded seal which is secured in a retaining part associated with one of the structural elements and has a contact face against the other structural element, and
that the seal communicates with a branch from a hose or a pipe for supply of the substance to the interspace, the side of the seal facing away from the second structural element being arranged to be subjected to pressure by the substance via said branch simultaneously with the supply of substance into the interspace, the substance, at a corresponding pressure and simultaneously with the supply to the interspace also being separately supplied to a pressure-applying face of the seal.

7. A device as disclosed in claim 6, characterised in
that the interspace is closed off at a first axial end area thereof and is open at a second axial end area thereof, said excess volume being designed to exit the interspace via said second end area.

8. A device as disclosed in claim 6, characterised in
that the interspace is closed off at both axial end areas; and
that the excess volume is designed to exit the interspace via an outlet located in the first structure element between said end areas

9. A device as disclosed in claim 6, 7 or 8, characterised in
that at said at least one end, two ring seals are provided.

10. A device as disclosed in claim 6, characterised in
that the seal, seen in cross-section, has a wave-shaped outer side and a straight rear side; and
that at least two valleys of the wave-shape are each designed to form a seat for a respective pressure-acting spring that surrounds the seal.

11. A device as disclosed in claim 6, characterized in that said substance is a lubricant or a cleaning agent.
